(19) United States
(12) Patent Application Publication
(10) Pub. No.: US 2026/0063852 A1
(43) Pub. Date: Mar. 5, 2026

(54) A FIBRE OPTIC CONNECTOR BODY, A KIT OF PARTS, A FIBRE OPTIC CONNECTOR AND USE OF THE SAME

(71) Applicant: Ridgemount Technologies Limited, Launton, Bicester Oxfordshire (GB)

(72) Inventors: Christopher Russell Peters, Launton, Bicester Oxfordshire (GB); Mark John Limbert, Launton, Bicester Oxfordshire (GB)

(21) Appl. No.: 19/105,795

(22) PCT Filed: Aug. 30, 2023
(86) PCT No.: PCT/GB2023/052241

§ 371 Date: Feb. 21, 2025

(30) Foreign Application Priority Data
Sep. 5, 2022 (GB) 2212916.7

(51) Int. Cl. G02B 6/38; G02B 6/54

(52) U.S. Cl. CPC G02B 6/3829; G02B 6/3821; G02B 6/389; G02B 6/545

(57) ABSTRACT

A fibre optic connector body for use with a fibre optic ferrule is described. Herein the fibre optic connector body comprises a housing portion, a connection portion extending from the housing portion, a central bore extending through the housing portion and the connection portion, wherein the connection portion comprises an outer perimeter and further wherein the outer perimeter of at least a section of the connection portion is a polygon with at least eight sides. A kit of parts including the fibre optic connect body, a fibre optic connector including the fibre optic connector body and use of the same are also described.

### FIELD

Principles disclosed herein pertain to fibre optic connector bodies for use with a ferrule, a kit of parts, a fibre optic connector and use of the same.

### BACKGROUND

LC (Lucent Connector) fibre optic connectors are well established. Such connectors are often preferred due to their single-mode transmittal providing a higher bandwidth over longer distances and their ability to be quickly terminated. Additionally, within such connectors, Angled Physical Contact (APC) alignment offers the benefit of reduced back reflection due to a degree of angle-polish applied to the connecting faces.

However, whilst LC fibre optic connectors have many benefits, there are some challenges with the technology in its current form. Presently, LC fibre optic connectors are not considered suitable for installation through walls due to their shape and size. In particular, it is undesirable and often impractical to create a large enough aperture through which an installer can pass the connector.

Further, the front housing of a standard LC fibre optic connector is configured to be permanently retained on the connector body. Any attempt to remove the front housing is liable to damage the connector. Even if an installer could remove the front housing of a standard LC connector, the connector itself remains too large to pass through small apertures during installation. Additionally, the sensitive components within the fibre optic connector would be liable to damage from impact and dust during the installation process, as they would be unprotected.

### SUMMARY

Disclosed principles address one or more of the foregoing or other needs. According to a first aspect, there is provided a fibre optic connector body for use with a fibre optic ferrule, the fibre optic connector body comprising: a housing portion; a connection portion extending from the housing portion; a central bore extending through the housing portion and the connection portion; wherein the connection portion comprises an outer perimeter, and further wherein the outer perimeter of at least a section of the connection portion is a polygon with at least eight sides.

In this way, there is provided a fibre optic connector body appropriate for through-wall installation, such as installation via a wall aperture into a building. The section of the connection portion having at least eight sides allows items to be twisted on to, and off of, the fibre optic connector body at various stages during the installation process. As such, the method of installing the fibre optic connector is not restricted by the bulky size of the LC front housing. Instead, the connector may have different items attached, then removed, from the connector body during the installation process to protect the fibre optic connector and then prepare it for subsequent use.

Preferably, the outer perimeter of at least a section of the connection portion is a polygon with eight sides. Preferably, the outer perimeter of at least a section of the connection portion is an equilateral or regular octagon (i.e. all sides of the octagon are equal in length). Preferably, the at least a section of the connection portion is the entire length of the connection portion. Preferably, the connection portion is formed by a hollow octagonal prism. In other words, the connection portion has eight walls, all of which having substantially the same length and width (and optionally depth, wherein the depth defines the thickness of the wall) such that the walls provide a regular octagon cross-section.

In some embodiments, the connection portion is configured to engage or disengage with another component (such as a pulling cap, an LC front housing, or any other object) by twisting. For example, a component (e.g. pulling cap, e.g. LC front housing) attached to the connection portion may be removed from the connection portion by (e.g. simultaneously) twisting off (e.g. twisting motion and pulling motion) the component (e.g. pulling cap, e.g. LC front housing) with respect to the fibre optic connector body. Similarly, a component (e.g. pulling cap, e.g. LC front housing) can be attached to the connection portion by twisting on (e.g. twisting motion and a pushing motion) the component (e.g. pulling cap, e.g. LC front housing) with respect to the fibre optic connector body. Similarly, the connection portion can engage and disengage with a cooperatively shaped cavity by twisting and pushing/pulling the fibre optic body with respect to the cavity. Preferably, the axis of rotation of the twisting motion is the longitudinal axis of the fibre optic connector body. As such, in some embodiments, a plurality of fibre optic connector bodies may each be received within one of a plurality of cavities of a multi-contact connector, wherein the connection portion of each fibre optic connector body is twisted into the cavity (e.g. to secure the fibre optic connectory body to the connector) and twisted out of the cavity (e.g. to facilitate cleaning, maintenance, replacement or reconfiguration).

As a result, the fibre optic connector body can have improved versatility and flexibility as different components (providing different functions at different stages in the installation process, e.g. a pulling cap for pulling through the wall, e.g. a cavity) may be easily and reversibly swapped onto and off of the connection portion. Similarly, the connection portion may be easily and reversibly inserted into and removed from a cavity.

Preferably, the housing portion comprises an outer perimeter wherein the outer perimeter of at least a section of the housing portion is a polygon. Preferably, the at least a section of the housing portion is the entire length of the housing portion. Most preferably, the outer perimeter of at least a section of the housing portion is a square with rounded corners, truncated circle, Superellipse-based squircle or Fernández-Guasti squircle. In this way, the cross-sectional area of the housing portion is reduced, allowing any connector to be installed through a smaller aperture.

Preferably, the connection portion further comprises at least one engagement tab. More preferably, the at least one engagement tab extends from an outer surface of the connection portion. Still more preferably, the connection portion comprises at least two engagement tabs, wherein the engagement tabs are located on opposing sides of the connection portion. In this way, the connection portion is configured to easily and securely engage with a pulling cap, an LC front housing, or any other object twisted on to the connection portion.

Preferably, at least one surface of the at least one engagement tab extends perpendicularly from the surface of the connection portion. Preferably, at least one surface of the at least one engagement tab is perpendicular to the longitudinal axis of the fibre optic connector body. Preferably, the at least one perpendicular surface is located distal an open end of the central bore and is parallel to the opening of the central bore. Preferably, the at least one perpendicular surface is a surface connected to at least one parallel surface. Preferably, the at least one engagement tab comprises at least one sloped surface. Preferably, the at least one sloped surface is connected to the at least one perpendicular surface and the at least one parallel surface. More preferably, the at least one sloped surface is an opposing pair of sloped surfaces connected to the at least one perpendicular surface and the at least one parallel surface.

When the connection portion is retained within an object, such as an LC front housing, the at least one perpendicular surface inhibits removal of the object from the connection portion in a direction parallel to the longitudinal axis of the fibre optic connector body. The at least one sloped surface enables removal of the object via a twisting motion in one or both directions, wherein the axis of rotation of the twisting motion is the longitudinal axis of the fibre optic connector body. In this way, improved retention of the connection portion within a pulling cap and/or an LC front housing is provided, whilst the removal of these items using a twisting force remains possible without damaging the connector.

Further, the engagement tabs allow an object, such as an LC front housing, to be removably retained on the fibre optic connector body. Such a feature is advantageous in that removal of the LC front housing from the connection portion is not inhibited when a twisting motion is applied, the axis of rotation of the twisting motion being the longitudinal axis of the fibre optic connector body. Similarly, the LC front housing can be positioned on the connection portion via a twisting motion. Therefore, the user can retrospectively fit the LC front housing to the connection portion after the fibre optic connector body has been passed through a wall aperture during installation. Such a feature is advantageous in that the wall aperture is not required to be large enough to allow the bulky LC front housing to pass through.

Preferably, within the connection portion the perimeter of the central bore is a polygon. More preferably, the polygon is an octagon, e.g. a regular octagon. Preferably, the polygon of the perimeter of the central bore and the polygon of the outer perimeter of the connection portion are aligned, wherein the connection portion has a constant thickness between the polygonal central bore and the polygonal outer perimeter.

Preferably, the polygonal outer perimeter of the housing portion and the polygonal outer perimeter of the connection portion have the same number of sides. Preferably, the polygonal outer perimeter of the housing portion is aligned with the polygonal outer perimeter of the connection portion, wherein each side of the polygonal outer perimeter of the housing portion is planar to a side of the polygonal outer perimeter of the connection portion.

Preferably, the outer surface of the housing portion comprises grooves. Preferably, the grooves are parallel to one another. More preferably, the grooves are parallel to the longitudinal axis of the fibre optic connector body. Preferably, the grooves are located along at least half the length of the housing portion. More preferably, the grooves are uninterrupted along the length of the housing portion. Preferably, the grooves comprise at least three grooves. More preferably, the grooves consist of three grooves. Preferably, the grooves are equally spaced about the housing portion. Preferably, the grooves are located on a first surface of the polygonal outer perimeter. Preferably, each groove is identical. Such a feature is advantageous in that the grooves act as visual and haptic identification of the orientation of the fibre optic connector body. In some embodiments, the grooves are configured to be located at the top of the fibre optic connector body during correct installation so that they can be easily seen by the user.

Preferably, within at least a portion of the housing portion the perimeter of the central bore comprises a plurality of splines. Preferably, the plurality of splines are uninterrupted along their length. Preferably, the plurality of splines are located along less than half of the length of the housing portion. More preferably, the plurality of splines are located along less than a third of the length of the housing portion. Preferably, the plurality of splines are located along more than a fifth of the length of the housing portion. The plurality of splines improve retention between the fibre optic connector body and other parts of a fibre optic ferrule sub-assembly, such as the crimp sleeve or crimp eyelet. The plurality of splines aid retention of a crimp sleeve inserted within a portion of the central bore of the housing portion.

Preferably, the fibre optic connector body comprises steel. More preferably, the fibre optic connector body comprises 316 stainless steel. Namely, grade 316 stainless steel contains an addition of molybdenum that affords it improved corrosion resistance. Preferably, the fibre optic connector body is a metal injection moulded fibre optic connector body. It is advantageous for the fibre optic connector body to be manufactured using metal injection moulding instead of conventional methods, such as plastic injection moulding, as greater precision can be achieved and an improved quality connector be provided. Greater manufacturing precision improves the ease and fit of the fibre optic connector body with other parts of a larger fibre optic ferrule sub-assembly, such as an LC front housing and a crimp sleeve. Further, a metal-to-metal fit press fit between the parts of a fibre optic ferrule sub-assembly, such as the crimp sleeve or crimp eyelet, provides improved retention compared to a plastic-to-metal fit. With a plastic-to-metal fit, additional resin may be required to secure the parts together.

Preferably, the outer surface of the housing portion is further from the longitudinal axis of the fibre optic connector body than the outer surface of the connection portion. Preferably, the outer surfaces of the housing portion and the connection portion have a stepped profile. Namely, the cross-section of the outer surfaces of the housing portion is constant along the direction of the longitudinal axis of the fibre optic connector body and the cross-section of the outer surface of the connection portion is constant along the direction of the longitudinal axis of the fibre optic connector body, such that the outer surfaces form a stepped profile.

Preferably, the smallest diameter of a portion of the outer perimeter of the housing portion is 4.5 mm. Preferably, the largest diameter of a portion of the outer perimeter of the housing portion is 4.8 mm. In this way, the fibre optic connector body is suitable for passing through a small aperture, such as a wall aperture with a 5-6 mm diameter.

Preferably, the fibre optic connector body comprises a crimp sleeve configured to be received within a portion of the central bore of the housing portion. Preferably, the crimp sleeve is configured to be received with a clearance fit. In this way, the crimp sleeve can be connected with a press-fit to the housing portion. In some embodiments, the crimp sleeve is configured to be received with an interference fit. Preferably, the crimp sleeve comprises a central aperture located through the length of the crimp sleeve. In this way, there is an uninterrupted path through the central bore and central aperture. Preferably, the crimp sleeve consists of metal.

Preferably, the fibre optic connector body comprises an Angled Physical Connect (APC) ferrule configured to be received within the central bore. Preferably, the fibre optic connector body further comprises a resilient member and at least a portion of the APC ferrule is configured to be received within the resilient member. Preferably, the APC ferrule comprises a resilient member abutting portion. Preferably, the resilient member is configured to be received within the central bore. Preferably, the resilient member is a spring. In this way, the APC ferrule can be sprung loaded within the central bore.

In some embodiments, the fibre optic connector body comprises a cable boot. Preferably, at least a portion of the crimp sleeve is configured to be received by the cable boot. Preferably, the cable boot is tapered, wherein the width of the cable boot is greater at a crimp sleeve receiving end than at a cable receiving end. Preferably, the cable boot comprises a central aperture. Preferably, at least a portion of the cable boot comprises a wall thickness of from 0.4 mm to 0.7 mm inclusive. More preferably, at least a portion of the cable boot comprises a wall thickness of from 0.5 mm to 0.65 mm inclusive. More preferably, the at least a portion is the crimp sleeve receiving end. In this way, a crimp sleeve can be received within the cable boot without increasing the width of the cable boot. Preferably, the cable boot is configured to receive a cable jacket.

According to a second aspect, there is provided a kit of parts comprising the fibre optic connector body of the first aspect and a removable pulling cap, wherein a first end of the removable pulling cap is configured to removably connect to the connection portion via a twisting motion.

In this way, the removable pulling cap can securely connect with the connection portion such that it can be used to pull the fibre optic connector body through an aperture, before being removed by a user with a twisting motion when the pulling process is complete.

Preferably, the first end of the removable pulling cap comprises an internal perimeter, and the internal perimeter is a polygon with at least eight sides. More preferably, the polygon is a polygon with eight sides. Preferably, the internal perimeter of the removable pulling cap is complementary to the outer perimeter of the connection portion. In this way, the connection between the removable pulling cap and the connection portion of the fibre optic connector body may be more secure during the pulling process itself, without inhibiting the ability of a twisting motion to remove the removable pulling cap when desired.

Preferably, the first end of the removable pulling cap comprises an external perimeter, and the external perimeter is a polygon with at least eight sides. More preferably, the polygon is a polygon with eight sides. Preferably, the internal perimeter and the external perimeter are aligned, wherein each side of the polygonal internal perimeter is planar to a side of the polygonal external perimeter. Preferably, at least a portion of the external perimeter of the removable pulling cap is identical to the outer perimeter of the housing portion. In this way, the pulling cap does not increase the cross-sectional area of the overall object that must be pulled through an aperture during installation.

Preferably, the smallest diameter of a portion of the external perimeter of the removable pulling cap is 4.5 mm. Preferably, the largest diameter of a portion of the external perimeter of the removable pulling cap is 4.8 mm. In this way, the removable pulling cap is suitable for passing through a small aperture, such as a wall aperture with a 5-6 mm diameter.

Preferably, the first end of the removable pulling cap comprises at least one slot extending parallel to the longitudinal axis of the removable pulling cap. More preferably, the removable pulling cap comprises a pair of slots located on opposing sides of the removable pulling cap. Preferably, each slot of the at least one slot is located on a face of the polygonal external perimeter. The at least one slot allows the pulling cap to more easily deform when a user is twisting the removable pulling cap on to, or off of, the connection portion, easing its installation and removal.

Preferably, the first end of the removable pulling cap comprises at least one indent or aperture for receiving at least one engagement tab. Preferably, the at least one indent or aperture comprises a pair of indents or apertures located on opposing sides of the removable pulling cap. Preferably, the pair of opposing slots and pair of opposing indents or apertures are equally spaced about the external perimeter of the removable pulling cap. In this way, the at least one engagement tab of the connection portion can be housed within the at least one indent or aperture, securing the pulling cap to the fibre optic connector body.

When the at least one engagement tab of the connection portion is housed within the at least one indent or aperture of the pulling cap, the at least one perpendicular surface of the at least one engagement tab inhibits removal of the pulling cap in a direction parallel to the longitudinal axis of the fibre optic connector body. However, the user can apply a twisting motion to the pulling cap, thereby urging the at least one engagement tab out of the at least one indent or aperture of the pulling cap. The axis of rotation of the twisting motion is the longitudinal axis of the fibre optic connector body. The twisting motion urges the pulling cap to deform and allows the user to remove the connection portion from the pulling cap. When the at least one engagement tab has exited the pulling cap, the pulling cap returns to its undeformed configuration.

Similarly, the at least one slot also improves the ease with which the connection portion can be inserted into the pulling cap. The connection portion can be urged into the pulling cap, the pulling cap deforming about the at least one slot to allow the at least one engagement tab to be received within the pulling cap. The user can then twist the pulling cap, the axis of rotation of the twisting motion being the longitudinal axis of the fibre optic connector body. When the at least one engagement tab is urged within the at least one indent or aperture of the pulling cap, the pulling cap no longer experiences a deforming force from the at least one engagement tab and returns to its undeformed configuration. The at least one sloped surface of the at least one engagement tab aids twisting motion of the pulling cap.

Preferably, a second end of the removable pulling cap comprises a pulling eye. Preferably, the second end comprises a domed or tapered portion. In this way, there may be greater ease of passage of the second end of the removable pulling cap through an aperture, such as an aperture in a wall or partition. Preferably, the axial direction of the eye of the pulling eye is perpendicular to the longitudinal axis of the pulling cap. Preferably, the axial direction of the eye of the pulling eye is parallel to the axial direction of the at least one indent or aperture. Preferably, the first end and the second end are connected via a tapered portion having a width narrower than the width of the first end and second end.

Preferably, the kit of parts further comprises a front housing, wherein a first end of the front housing is configured to removably connect to the connection portion via a twisting motion. In this way, the front housing can securely connect with the connection portion with a twisting motion when the pulling process is complete and the removable pulling cap has been removed.

Preferably, the kit of part comprises a removable dust cap. More preferably, the kit of parts is configured such that the removable dust cap can be accommodated with the removable pulling cap. Still more preferably, the removable dust cap is detachable from the removable pulling cap. Preferably, the removable dust cap is sized to pass through the front housing. The removable dust cap is configured, in use, to protect a polished fibre ceramic within the fibre optic connector body.

The use of a separate dust cap provides further protection for sensitive parts of the fibre optic connector during the installation process. Firstly, the dust cap acts as a second barrier, beyond the removable pulling cap, preventing dust and other contaminants from reaching the sensitive areas of the connector during the installation process. Secondly, after the removable pulling cap has been removed and the front housing has been installed, the removable dust cap may remain in place until the final connection is made.

Preferably, the first end of the front housing comprises an internal perimeter, and wherein the internal perimeter is a polygon with at least eight sides. More preferably, the polygon is a polygon with eight sides. Preferably, the internal perimeter of the front housing is complementary to the outer perimeter of the connection portion.

Preferably, the first end of the front housing comprises at least one slot extending parallel to the longitudinal axis of the front housing.

Preferably, the first end of the front housing comprises at least one indent or aperture for receiving at least one engagement tab.

According to a third aspect, there is provided use of the kit of parts of the second aspect in the installation of a fibre optic cable.

According to a fourth aspect, there is provided a fibre optic connector comprising the body of the first aspect.

### DETAILED DESCRIPTION

Embodiments of disclosed principles will now be described by way of example only and with reference to the accompanying drawings, in which:

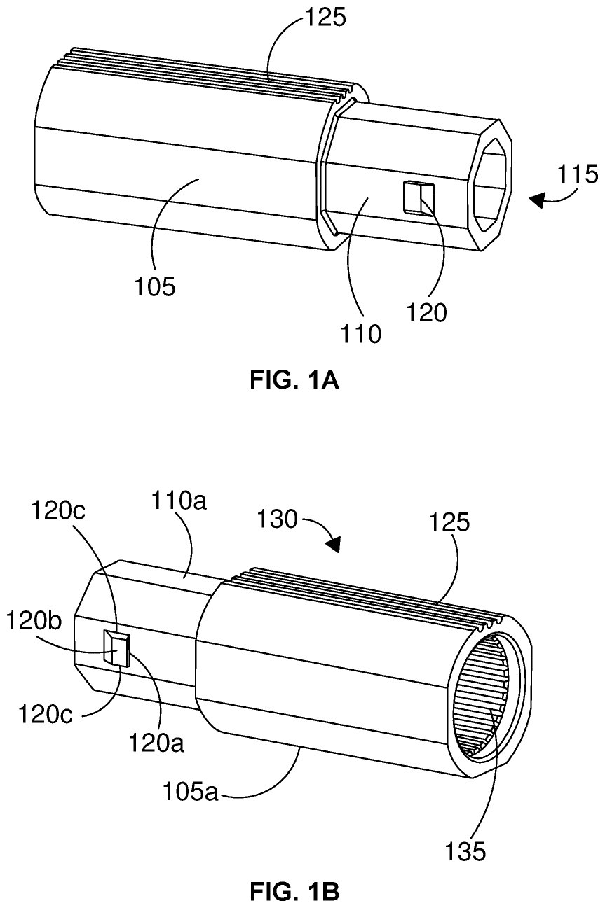

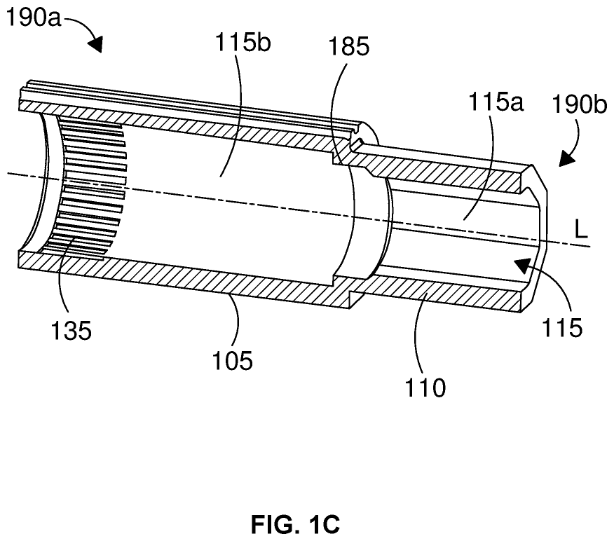

FIGS. 1A and 1B are perspective views of a housing portion and a connecting portion of a fibre optic connector body in accordance with the first aspect;

FIG. 1C is a deconstructed view of the housing portion and the connecting portion of the fibre optic connector body of FIG. 1A;

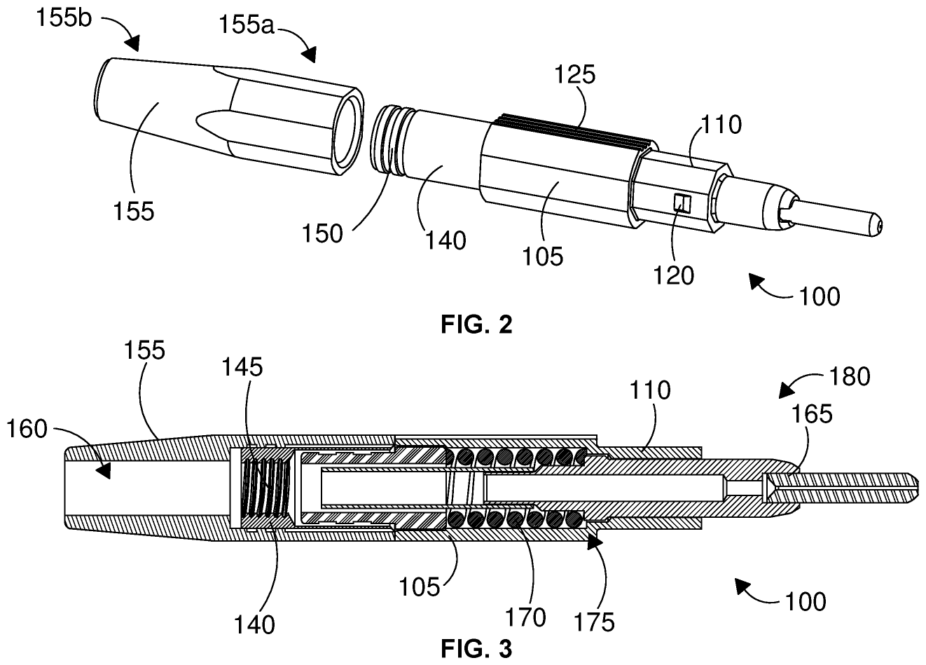

FIG. 2 is a further perspective view of the fibre optic connector body of FIG. 1A;

FIG. 3 is a deconstructed view of the fibre optic connector body of FIG. 1A;

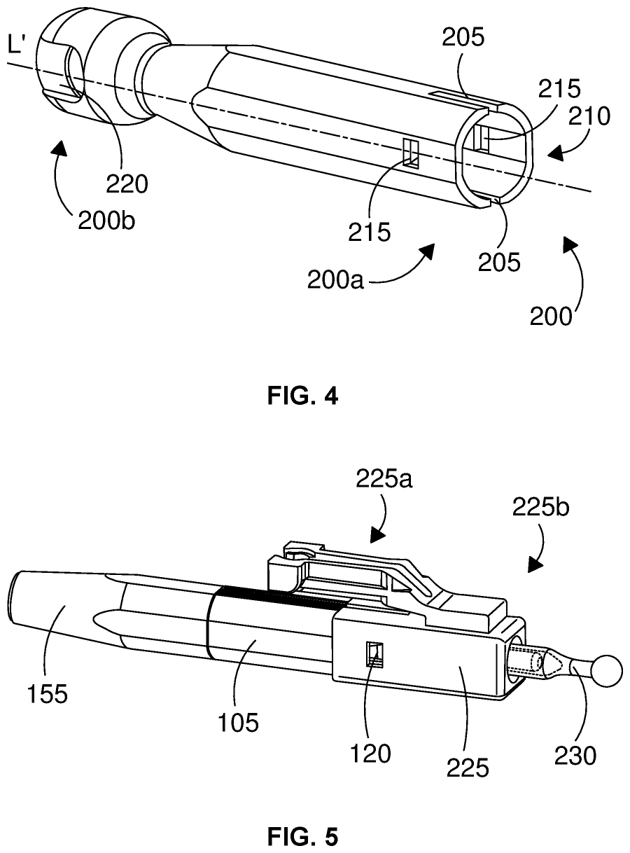

FIG. 4 is a perspective view of a removable pulling cap in accordance with the second aspect;

FIG. 5 is a perspective view of a kit of parts according to the second aspect;

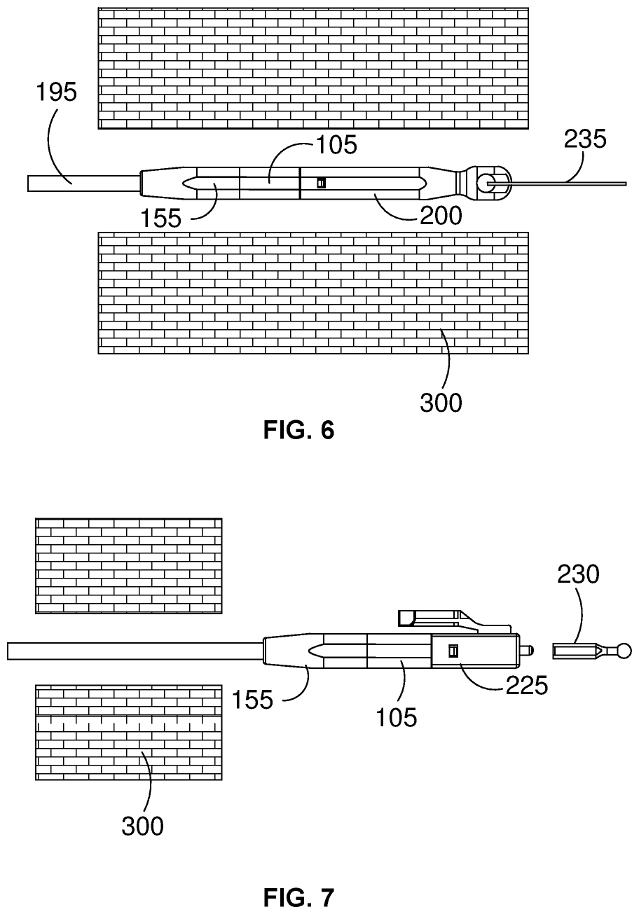

FIG. 6 is a side view of the kit of parts of the second aspect, illustrated during installation of the kit of parts through an aperture; and

FIG. 7 is a side view of the kit of parts of FIG. 6, illustrated during installation of the kit of parts through an aperture.

With reference to FIGS. 1-3, there is illustrated a fibre optic connector body 100, for use with a fibre optic ferrule, in accordance with the first aspect. The fibre optic connector body 100 comprises a housing portion 105 and a connection portion 110 extending from the housing portion 105. The housing portion 105 and connection portion 110 are formed from a single piece of grade 316 stainless steel manufactured using metal injection moulding.

The connection portion 110 comprises an outer perimeter 110a and the outer perimeter 110a is an eight-sided polygon along the entire length of the connection portion 110. The housing portion 105 also comprises an outer perimeter 105a which is an eight-sided polygon along the entire length of the housing portion 105. The polygonal outer perimeter 105a of the housing portion 105 is aligned with the polygonal outer perimeter 110a of the connection portion 110, wherein each side of the polygonal outer perimeter 105a of the housing portion 105 is planar to a side of the polygonal outer perimeter 110a of the connection portion 110.

The connection portion 110 comprises a pair of engagement tabs 120 extending from an outer surface of the connection portion 110. It is understood that the outer surface is the surface formed by the outer perimeter 110a of the connection portion 110. The engagement tabs 120 are located on opposing sides of the connection portion 110, such that they are equally spaced about the outer perimeter 110a of the connection portion 110. Each engagement tab 120 comprises a first surface 120a perpendicular to the outer surface of the connection portion 110 and a second surface 120b parallel to the connection portion 110. Connected to the first surface 120a and second surface 120b are two sloped surfaces 120c.

The outer surface of the housing portion 105 comprises three identical grooves 125. It is understood that the outer surface is the surface formed by the outer perimeter 105a of the housing portion 105. The grooves 125 are parallel to the longitudinal axis L of the fibre optic connector body 100 and are continuous along the entire length of the housing portion 105. The grooves 125 are equally spaced along a first face 130 of the outer surface having a regular octagon shape. In this way, the grooves 125 are only located on a single face of the outer surface of the housing portion 105. When the fibre optic connector body 100 is correctly installed, such as in a receiver or transmitter, the grooves 125 are configured to be located on the uppermost surface of the outer perimeter 105a of the housing portion 105. The cross-sectional perimeter of the housing portion 105 is generally a square with rounded corners.

As illustrated in FIGS. 1A-1C, the outer surfaces of the housing portion 105 and the connection portion 110 have a stepped profile, wherein the outer surface of the housing portion 105 is further from the longitudinal axis L of the fibre optic connector body 100 than the outer surface of the connection portion 105. In this way, the width of the housing portion 105 is greater than the width of the connection portion 110.

A central bore 115 extends through the housing portion 105 and the connection portion 110, along a longitudinal axis L of the fibre optic connector body 100. Within the connection portion 110 the perimeter 115a of the central bore 115 is a regular octagon which is aligned with the outer perimeter 110a of the connection portion 110 also having a regular octagon shape. As illustrated in FIG. 1C, the connection portion 110 has a constant thickness between the octagonal perimeter 115a of the central bore 115 and the octagonal outer perimeter 110a.

Within the housing portion 110, a portion of the perimeter 115b of the central bore 115 comprises a plurality of identical splines 135. Each spline 135 is uninterrupted along its length and extends a quarter of the length of the housing portion 110. The splines 135 are equidistant about the perimeter 115b of the central bore 115 and are located at a first end 190a of the central bore 115.

The fibre optic connector body 100 further comprises a metal crimp sleeve 140 configured to be received within a portion of the central bore 115 of the housing portion 105. The crimp sleeve 140 is cylindrical and assists in retaining a fibre optic cable within the central bore 115. The crimp sleeve 140 comprises a central aperture parallel to the longitudinal axis L of the fibre optic connector body 100 when the crimp sleeve 140 is received within the central bore 115. In this way, there is an uninterrupted path through the central bore 115 and central aperture, such that a fibre optic cable may be retained within the fibre optic connector body 100. The central aperture comprises a threaded portion 145. An external surface of the crimp sleeve 140 comprises a cable boot mating portion 150 comprising three mating grooves configured to aid retention of the crimp sleeve 140 when received within a cable boot 155. The crimp of the crimp sleeve 140 is a 0.12 inch round crimp known in the art.

The fibre optic connector body 100 further comprises a cable boot 155. The crimp sleeve 140 is configured to be simultaneously retained within the housing portion 105 and the cable boot 155 such that a first end of the crimp sleeve 140 is located within the housing portion 105 and the opposing distal end is located within the cable boot 155, as illustrated in FIG. 3. The cable boot 155 is tapered from a crimp sleeve receiving end 155a to a cable receiving end 155b.

The cable boot 155 comprises a central aperture 160 extending through the length of the cable boot 155 and parallel to the longitudinal axis L of the fibre optic connector body 100. The crimp sleeve 140 is configured to be received in a first end of the central aperture 160 and a cable jacket 195 is configured to be received in an opposing second end of the central aperture 160. The cable boot 155 further comprises a truncated thread located at the first end of the central aperture 160 configured to aid retention of a cable jacket received within the cable boot 155. In this way, a cable jacket can be received within the cable boot 155 without requiring a heat-shrink connection. The minimum wall thickness of the cable boot 155 about the second end of the central aperture 160 is between 0.5-0.86 mm.

In use, when the crimp sleeve 140 is retained within the housing portion 105 and the cable boot 155, an uninterrupted aperture is present through the length of the fibre optic connector body 100. In this way, fibre optic fibres, such as fibre optic fibres in a ferrule can be housed within and protected by the fibre optic assembly.

The fibre optic connector body 100 further comprises an Angled Physical Connect (APC) ferrule 165 configured to be received within the central bore 115. An exposed end 180 of the APC ferrule 165 is configured to connect to another fibre optic fibre or into a transmitter or receiver. The exposed end 180 is angled to minimise back reflection within the fibres. The fibre optic connector body 100 further comprises a spring 170 configured to be received within the central bore 115 of the housing portion 105. A portion of the APC ferrule 165 is configured to be received within the spring 170, wherein the APC ferrule 165 comprises a spring abutting portion 175. When the spring 170 is received within the central bore 115 and the APC ferrule 165 is received within the central bore 115, the spring abutting portion 175 abuts the spring 170 such that the APC ferrule 165 is spring-loaded in the central bore 115.

To assemble the fibre optic connector body 100, the APC ferrule 165 is inserted into the first end 190a of the central bore 115, the first end 190a being located at the open end of the housing portion 105. As illustrated in FIG. 3, when the APC ferrule 165 is received in the central bore 115, a portion of the APC ferrule 165 protrudes from a second end 190b of the central bore 115. The APC ferrule 165 is prevented from exiting the second end 190b by a shoulder 185 within the central bore 155 formed at the connection point of the stepped profile between the connection portion 110 and the housing portion 105.

Further, the spring 170 can be received within the central bore 115, with a portion of the APC ferrule 165 received within the spring 170. When the crimp sleeve 140 is fully inserted and received within the central bore 115, a portion of the crimp sleeve 140 abuts the spring 170 and provides a force compressing the spring against the spring abutting portion 175 of the APC ferrule 165. Epoxy resin is provided at the connection of the crimp sleeve 140 in the first end 190a to improve retention of the crimp sleeve 140 within the central bore 115.

A force may be provided on the exposed end 180 of the APC ferrule 165 in a direction towards the second end 190b, namely the user may provide a force urging the exposed end 180 towards the central bore 115, such as when the exposed end 180 is urged into a transmitter or receiver. In such instances, a compression force is provided on the spring 170 via the spring abutting portion 175. In this way, the APC ferrule 165 is sprung-loaded in the central bore 115, reducing the risk of damage to the APC ferrule.

With reference to FIGS. 4-7, a kit of parts according to the second aspect is shown, the kit of parts comprising the fibre optic connector body 100 and a removable pulling cap 200 comprising a first end 200a and a second end 200b. The cap 200 comprises a connection portion receiving aperture 210 configured to receive the connection portion 110 of the fibre optic connector body 100. The connection portion receiving aperture 210 is located in the first end 200a and does not extend into the second end 200b of the cap 200. The connection portion receiving aperture 210 defines an internal perimeter of the first end 200a. The first end 200a of the cap 200 comprises an internal perimeter having a regular octagon shape and an external perimeter having a regular octagon shape aligned with the internal perimeter. In this way, each side of the internal perimeter is planar to a side of the external perimeter.

The octagonal internal perimeter of the connection portion receiving aperture 210 is complementary to the octagonal outer perimeter 110a of the connection portion 110. In this way, the connection portion 110 is guided into the cap 200.

The first end 200a of the cap 200 comprises a pair of identical slots 205 located on opposing sides of the cap 200 and extending parallel to a longitudinal axis L′ of the cap 200. The slots 205 extend from the opening of the connection portion receiving aperture 210. The first end 200a further comprises a pair of apertures 215 located on opposing sides of the cap 200. The pair of slots 205 and pair of apertures 215 are equally spaced about the outer perimeter of the cap 200 from one another. The pair of slots 205 permit the cap 200 to deform elastically when an object slightly larger than the connection portion receiving aperture 210 is received within the connection portion receiving aperture 210.

The pair of apertures 215 are configured to receive the pair of engagement tabs 120 of the connection portion 110. In this way, the cap 200 can be removably retained on the fibre optic connector body 100. The first end 100a of the removable pulling cap 200 is configured to removably connect to the connection portion 110 via a twisting motion. Namely, when the connection portion 110 is received within the cap 200, a user can rotate the cap 200 with the longitudinal axis L of the fibre optic connector body 100 as the rotational axis, to remove the cap 200 from the fibre optic connector body 100.

The connection portion 110 is configured to be received within the front housing 225 with a clearance fit when the engagement tabs 120 are located within the pair of apertures 215. The connection portion 110 is configured to be received within the front housing 225 with an interference fit when the engagement tabs 120 are not located within the pair apertures 215. Therefore, the slots 205 allow the cap 200 to elastically deform when the engagement tabs 120 are urged out of the pair of apertures 215 to allow the connection portion 110 to be received within and removed from the cap 200.

When the engagement tabs 120 are housed within the pair of apertures 215, the perpendicular first surface 120a of the engagement tabs 120 inhibits removal of the cap 200 in a direction parallel to the longitudinal axis L of the fibre optic connector body 100. However, the user can apply a twisting motion to the cap 200, thereby urging the sloped surfaces 120c of the engagement tabs 120 out of the pair of apertures 215 of the pulling cap 200. The twisting motion urges the cap 200 to deform about the slots 205 and allows the user to remove the connection portion 110 from the cap 200. When the engagement tabs 120 have exited the cap 200, the cap 200 returns to its undeformed configuration. Similarly, the slots 205 improve the ease of insertion of the connection portion 110 into the pulling cap 200.

The second end 200b of the cap 200 comprises a pulling eye 220 and the axial direction of the pulling eye 220 is perpendicular to the longitudinal axis L′ of the cap 200. As illustrated in FIG. 6, a pulling member 235 can be inserted into the pulling eye 220. The pulling member 235 may be any appropriate means for retention within the pulling eye 220 such as a cord, wire, string and/or hook. Such a feature is particularly advantageous to aid the insertion of the fibre optic connector body 100 into an aperture or other channel in a wall 300. During fibre optic installation, the fibre optic cables are often passed through one or more walls into the room of the building in which they are being installed. If the fibre optic connector body 100 and cap 200 assembly or the cap 200 fall within a cavity, the pulling eye 220 aids retrieval of the fibre optic connector body 100 from any cavity, as well as guidance through the aperture.

The kit of parts further comprises a front housing 225 and a dust cap 230. The front housing 225 comprises a first end 225a configured to removably connect to the connection portion 110 via a twisting motion and a second end 225b configured to receive the dust cap 230. The dust cap 230 is configured to be located over the fibre optic connection of the APC ferrule 165 and inhibits dust and other contaminants from interfering with the fibre optic connection of the APC ferrule 165. The first end 225a of the front housing 225 comprises an internal perimeter having a regular octagon shape (not pictured) complementary to the regular octagon outer perimeter 110a of the connection portion 110. In this way, the connection portion 110 is guided into the front housing 225.

The pulling cap 200 is configured to house the dust cap 230. The polished fiber ceramic of the fibre optic connection of the APC ferrule 165 is protected from contaminants by the dust cap 230 during installation. Such a feature is advantageous as when the fiber optic connector body 100 has been pulled or pushed through a wall aperture, there is a high likelihood of contamination. Upon removal of the pulling cap 200 with a twisting motion, the dust cap provides a second barrier to ensure the fibre optic connection is clean and dust-free. The fiber optic connector body 100 can be cleaned by wiping or blowing with air after installation through a wall aperture and prior to attaching the front housing 225. The front housing 225 is configured to house a portion of the dust cap 230. In this way, while attaching the front housing 225 with a twisting motion, the dust cap 230 remains fitted to the polished fiber ceramic of the fibre optic connection and passes through the front housing 225. Such a feature is advantageous as it allows the user to remove the dust cap 230 and expose the fiber optic only when the front housing 225 has been attached to the connection portion 110 and the fibre optic connection is ready for installation.

In a similar manner to the pulling cap 200, the front housing 225 comprises a pair of apertures 215 located on opposing sides of the front housing 225 and configured to receive the pair of engagement tabs 120 of the connection portion 110. In a similar manner to the cap 200, a user can rotate the front housing 225 with the longitudinal axis L of the fibre optic connector body 100 as the rotational axis, to remove the front housing 225 from the fibre optic connector body 100.

With reference to FIGS. 6 and 7, use of the kit of parts of the second aspect in the installation of a fibre optic cable is illustrated. In FIG. 6, the fibre optic connector body 100 and attached pulling cap 200 are shown during insertion into a 5 mm wide aperture in a wall 300. The fibre optic connector body 100 houses the APC ferrule 165 comprising a fibre optic cable which is being fed from outside the wall 300 to the inside of the wall 300 with the aid of the pulling cap 200. The pulling member 235 comprises a cord tied to the pulling eye 220 which is held by a user located on the inside of the wall 300 onto which the pulling force can be applied. As the cord is coupled to the fibre optic cable via the pulling cap 200 and fibre optic connector body 100, the fibre optic cables can be easily fed through the small aperture in the wall 300. Further, the pulling cap 200 and fibre optic connector body 100 protect the fibre optic cable from damage and contaminants during installation.

Once the fibre optic connector body 100 is located inside the wall, such as inside the room of the building in which the fibre optic cable is being installed, the user can twist and remove the cap 200, thereby exposing the dust cap 230. The user can then insert the fibre optic connector body 100 into the LC front housing 225 and remove the dust cap 230 such that the fibre optic cable is exposed and ready for installation. The dust cap 230 and the pulling cap 200 can be put aside for reuse or discarded as appropriate.

1. A fibre optic connector body for use with a fibre optic ferrule, said fibre optic connector body comprising:
a housing portion;
a connection portion extending from said housing portion;
a central bore extending through said housing portion and said connection portion;
wherein said connection portion comprises an outer perimeter,
and further wherein said outer perimeter of at least a section of said connection portion is a polygon with at least eight sides.

2. The fibre optic connector body of claim 1, wherein said outer perimeter of at least a section of said connection portion is a regular octagon.

3. The fibre optic connector body of claim 1, wherein said connection portion further comprises at least one engagement tab.

4. The fibre optic connector body of claim 3, wherein said at least one engagement tab extends from an outer surface of said connection portion.

5. The fibre optic connector body of claim 3, wherein said connection portion comprises at least two engagement tabs, wherein said engagement tabs are located on opposing sides of said connection portion.

6. The fibre optic connector body of claim 3, wherein at least one surface of said at least one engagement tab extends perpendicularly from the surface of said connection portion.

7. The fibre optic connector body of claim 6, wherein said at least one surface of said at least one engagement tab is perpendicular to the longitudinal axis of said fibre optic connector body.

8. The fibre optic connector body of claim 1, wherein within said connection portion the perimeter of said central bore is a polygon.

9. The fibre optic connector body of claim 8, wherein said polygon is a regular octagon.

10. The fibre optic connector body of claim 1, wherein the outer surface of said housing portion comprises grooves.

11. The fibre optic connector body of claim 1, wherein within at least a portion of said housing portion the perimeter of said central bore comprises a plurality of splines.

12. The fibre optic connector body of claim 1, wherein said fibre optic connector body comprises 316 stainless steel.

13. A kit of parts comprising:
a fibre optic connector body for use with a fibre optic ferrule, said fibre optic connector body comprising:
a housing portion;
a connection portion extending from said housing portion;
a central bore extending through said housing portion and said connection portion;
wherein said connection portion comprises an outer perimeter,
and further wherein said outer perimeter of at least a section of said connection portion is a polygon with at least eight sides; and
a removable pulling cap, wherein a first end of said removable pulling cap is configured to removably connect to said connection portion via a twisting motion.

14. The kit of parts of claim 13, wherein said first end of said removable pulling cap comprises an internal perimeter, and wherein said internal perimeter is a polygon with at least eight sides.

15. The kit of parts of claim 14, wherein said polygon is a polygon with eight sides.

16. The kit of parts of claim 13, wherein said first end of said removable pulling cap comprises at least one slot extending parallel to the longitudinal axis of said removable pulling cap.

17. The kit of parts of claim 13, wherein said first end of said removable pulling cap comprises at least one indent or aperture for receiving at least one engagement tab.

18. The kit of parts of claim 13, wherein a second end of said removable pulling cap comprises a pulling eye.

19. The kit of parts of claim 13, wherein said kit of parts further comprises a front housing, wherein a first end of said front housing is configured to removably connect to said connection portion via a twisting motion.

20. The kit of parts of claim 19, wherein said first end of said front housing comprises an internal perimeter, and wherein said internal perimeter is a polygon with at least eight sides.

21. The kit of parts of claim 20, wherein said polygon is a regular octagon.

22. The kit of parts of claim 19, wherein said first end of said front housing comprises at least one slot extending parallel to the longitudinal axis of said front housing.

23. The kit of parts of claim 19, wherein said first end of said front housing comprises at least one indent or aperture for receiving at least one engagement tab.

24. A method of installation of installing a fibre optic cable, the method comprising:
providing a kit of parts comprising:
a fibre optic connector body for use with a fibre optic ferrule, said fibre optic connector body comprising:
a housing portion;
a connection portion extending from said housing portion;
a central bore extending through said housing portion and said connection portion;
wherein said connection portion comprises an outer perimeter,
and further wherein said outer perimeter of at least a section of said connection portion is a polygon with at least eight sides; and
a removable pulling cap having a first end configured to removably connect to said connection portion via twisting motion; and
removably connecting the first end of said removable pulling cap to removably connect to said connection portion by applying a twisting motion to the removable pulling cap relative to the connection portion.

25. A fibre optic connector comprising a fibre optic connector body for use with a fibre optic ferrule, said fibre optic connector body comprising:
a housing portion;
a connection portion extending from said housing portion;
a central bore extending through said housing portion and said connection portion;
wherein said connection portion comprises an outer perimeter,
and further wherein said outer perimeter of at least a section of said connection portion is a polygon with at least eight sides.
